(19) United States
(12) Patent Application Publication
(10) Pub. No.: US 2001/0033294 A1
(43) Pub. Date: Oct. 25, 2001

(54) Method and system for website maintenance

(76) Inventors: Arlyn Asch, San Diego, CA (US); Ronald A. Linyard, San Diego, CA (US); Arie Trouw, Encinitas, CA (US); Mark Wineman, San Diego, CA (US); Jonas Salling, San Diego, CA (US); Brian C. Sparks, Santee, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/805,417

(22) Filed: Mar. 13, 2001

Related U.S. Application Data
(60) Provisional application No. 60/188,959, filed on Mar. 13, 2000.

(51) Int. Cl. G06F 17/00

(52) U.S. Cl. 345/705; 707/104.1; 345/708

(57) ABSTRACT

A system and method for tracking access and usage of a help system. The system the invention tracks and records all movements of the user within the help system. Tracking usage patterns helps identify trouble spots within the website. One factor tracked and recorded is the point in the transaction, for example, at which the user required help. Additionally, the help system tracks and records each search request from the user and the help topics selected by the user. Further, the help system tracks and records whether the user successfully resolved the problem and completed the transaction or abandoned the site. For identification and categorization of the user, the help system tracks and records data such as the type of browser used by the user, the user's IP address and the site referring the user to the current website. Additional information may be tracked and recorded as needed.

### RELATED APPLICATIONS

This application claims priority to, and incorporates by reference in its entirety, U.S. Provisional patent application No. 60/188,959, filed Mar. 13, 2000, titled METHOD AND SYSTEM FOR WEBSITE MAINTENANCE.

### FIELD OF THE INVENTION

The invention relates to maintenance of a website. In particular, the invention relates to gathering website user help data and modifying the website through the use of a feedback loop using the gathered data.

### BACKGROUND OF THE INVENTION

The use of the Internet and the World Wide Web as tools of commerce and for content delivery has increased dramatically in recent years. As a consequence of this increase, websites have generally incorporated an increasing number of features to accommodate the increasing demand of users. Additionally, in the competition for a larger share of the e-commerce market, websites have added an ever-increasing number of features and content to attract consumers. In order to compete, websites must stay ahead of the competition by constantly adding more content and more functionality.

This increase in functionality is naturally accompanied by an increased complexity for the user. Additionally, the average user of the website is no longer the highly adept, technical user; it is, instead, the mass-market, non-technical user.

As a result of this complexity, many users abandon the website prior to completing a transaction. This results in a severe loss of revenue to website operators and a substantial decrease in the efficiency of the websites.

Several tools have emerged to address the increased complexity of websites. First, basic help text may be provided for access by users. However, this text typically provides a general overview of the site and its features. Also, an increase in the functionality of the website results in an increase in the amount of help text a user must decipher. Thus, a user may experience difficulty navigating the help system itself.

Second, site maps attempt to orient users to the website and to enable them to navigate through the site. However, these maps are useless to a user experiencing difficulty completing a transaction or running a website application.

Third, search engines provide a method of finding information on the website. While search engines allow for improved navigability, they require the user to have some sort of knowledge of the desired solution. Thus, the typical user may still experience the same difficulties.

Additionally, users continue to experience difficulties since each website uses a different method of help. Thus, the user must re-learn a help system each time he logs into a different site. Even the same tools may be implemented to operate differently on different sites. Finally, existing help methods do not provide any method of improving the website.

### SUMMARY OF THE INVENTION

A method according to the present invention comprises providing electronic help on a website; collecting usage data from the electronic help; and providing reports indicative of the usage data for improving the website.

The method according to the present invention may farther comprise modifying the website based on the reports. The reports may be generated automatically upon receipt of usage data.

The usage data may include at least a browser type, a user address and a requested help topic.

A system of website help according to the present invention comprises a tracking module for tracking and logging movements of a user in a help environment; a recording module for recording information pertaining to the user and to the movements; and a reporting module for reporting usage of the help environment.

The recording module may record information according to a standard format. The recording module may record at least a browser type used by the user, an address identifying the user and a help topic requested by the user.

### BRIEF DESCRIPTION OF THE DRAWINGS

FIG. 1 is an overview of a system according to the present invention.

FIG. 2 is a screen shot of a single-pane help window.

FIG. 3 is a screen shot of a two-pane help window.

FIG. 4 is a screen shot of a help window using pop-up bubbles.

FIG. 5 is a display of the help system implemented on a website.

FIG. 6 is a sample recording of a user's movements in the help system.

FIGS. 7a and 7b are samples of reports generated by the present invention.

FIG. 8 is a schematic overview of an architecture of an embodiment of the present invention.

### DESCRIPTION OF THE INVENTION

The present invention addresses the growing difficulty of maintaining the usability of complex websites, particularly those relating to Internet commerce, and the inadequacy of existing “customer service” applications.

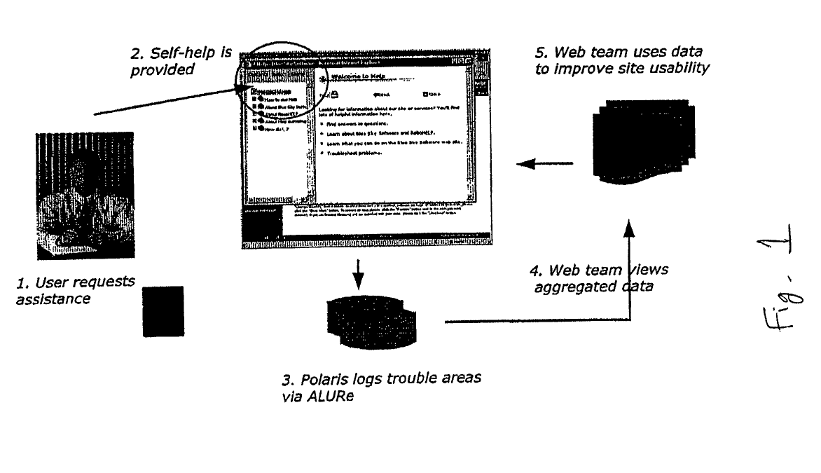

FIG. 1 illustrates a system of website maintenance according to the present invention. At stage 1, an online user logged into a complex website, such as a typical e-commerce site, experiences difficulty using, for example, a feature of the site. The user requests assistance from an online help system provided on the complex website.

The help system, as illustrated in stage 2, is available within the website and provides help on topics specific to the website. In one embodiment of the invention, the help system is a standardized and structured system. Standardization allows the user to learn from experience with other sites, eliminating the need to re-learn a help system for each individual site. Standardization, nevertheless, allows the maintaining of a uniqueness to each site with regard to the tools employed and the information contained in the help system.

The help system contains extensive text for help on numerous topics relating to the use of the website. For ease of use, the text may be organized via a comprehensive index or a table of contents, allowing access to the help text using, for example, hyperlinks.

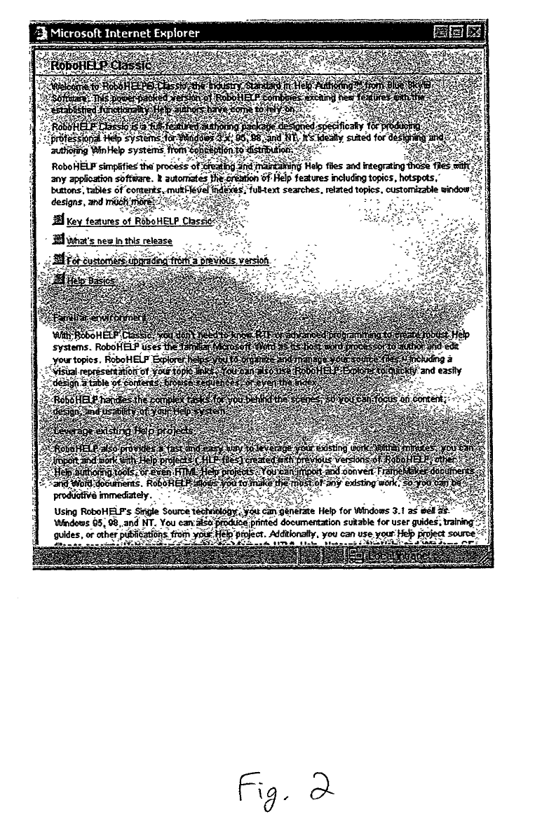

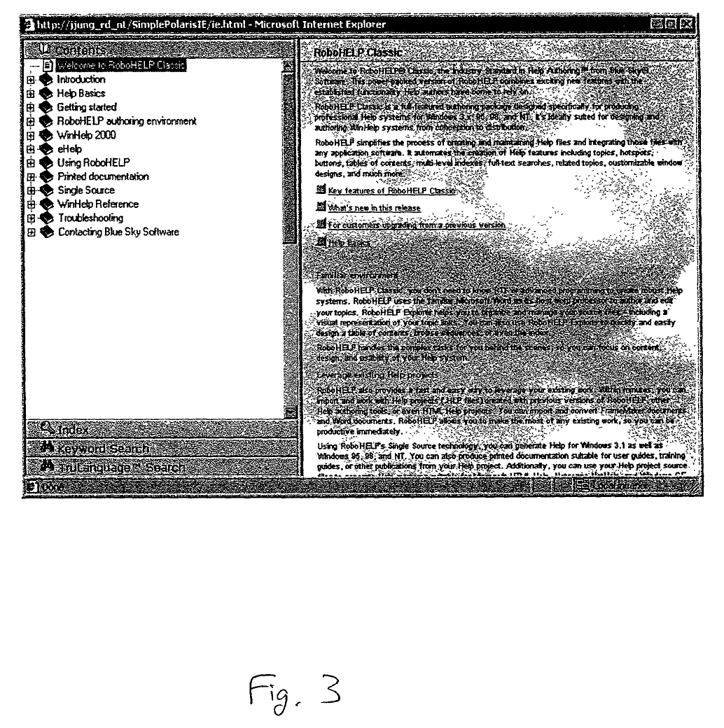

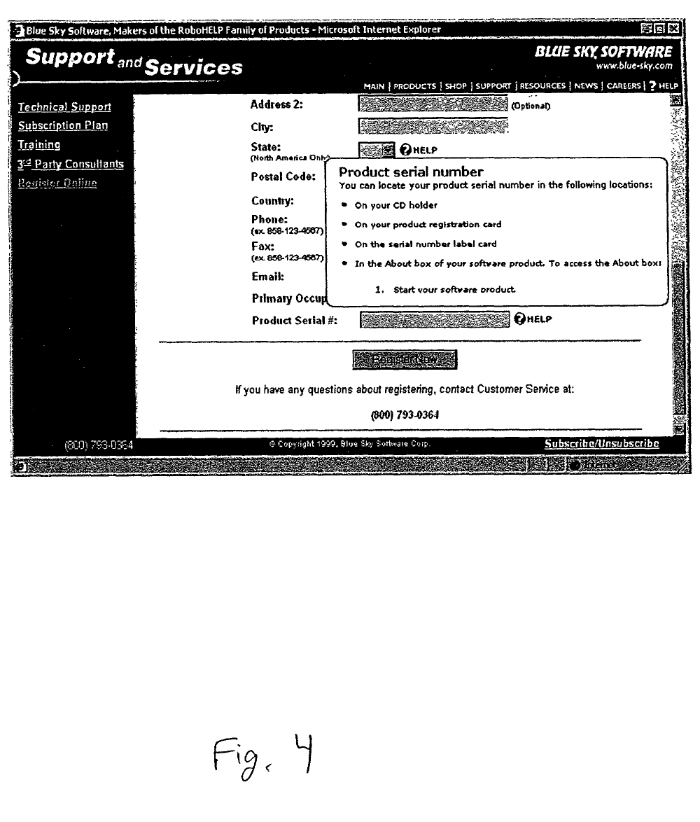

The help feature may be designed to appear on the user's monitor in one of three ways. First, as shown in FIG. 2, the help information may be viewed in a “single pane” of the browser window. This view displays all possible topics available for help on the website. Second, FIG. 3 illustrates a “two-pane” view. In this view, one pane is used to display all the help topics available, while a second pane is used to display navigation controls such as a table of contents, an index or search window. Third, a “pop-up bubble” may be used, as shown in FIG. 4. The bubble appears within the working page and provides specific help information without requiring the user to leave the current web page. In one embodiment, the bubble has a non-rectangular border for ease of viewing.

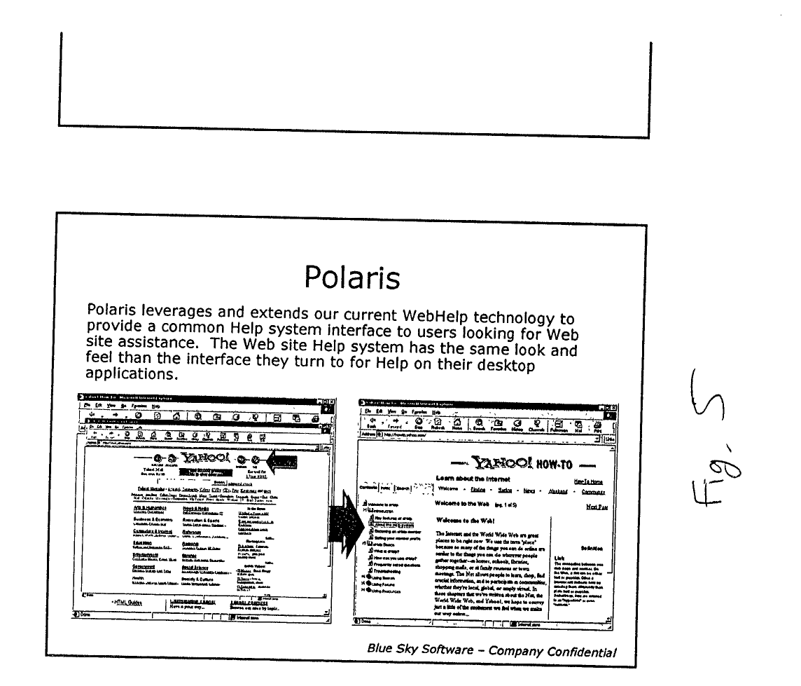

The help system of the present invention is designed to appear similar to help systems commonly employed in desktop applications. This provides the user with familiarity to the help system, allowing ease of use. FIG. 5 illustrates the implementation of the help system of the present invention in a website.

In addition to offering a table of contents and an index, the help system may also allow full-text search of the help information available on the website. The help system finds all topics relating to the terms entered by the user and displays them in a pane. In addition to such a keyword search, the help system also allows a natural language search.

The help system of the present invention is sensitive to the context in which help is sought. When the user requests help, he is presented with help information directly associated with his location in the website. For example, if the user requests help from the credit-card screen, he is provided with help topics and help information relating to the entering of credit-card information.

At stage 3 of FIG. 1, the invention tracks and records all movements of the user within the help system. This allows identification and reporting of trouble spots within the website. One factor tracked and recorded by the invention is the point in the transaction, for example, at which the user required help. Additionally, the invention tracks and records each search request from the user and the help topics selected by the user. Further, the invention tracks and records whether the user successfully resolved the problem and completed the transaction or abandoned the site. For identification and categorization of the user, the invention tracks and records data such as the type of browser used by the user, the user's IP address and the site referring the user to the current website. Additional information may be tracked and recorded as needed.

The information is recorded in a database. In one embodiment, the data is recorded according to an open standard format such as Aggregation and Logging of User Requests (ALURe™). The specification for ALURe, as adopted by an open standards committee and documented in “ALURe XML Specification”, is hereby incorporated by reference. ALURe is defined using the Extensible Markup Language (XML), as documented in “Extensible Markup Language (XML) 1.0,” World Wide Web Consortium (W3C) Recommendation, REC-xm1-19980210, Feb. 2, 1998, http://www.w3.org/TR/1998/REC-xm1-19980202, which is hereby incorporated by reference. Such standardization allows normalization of the information gathered using any available tool and facilitates the generation of standard or customized reports.

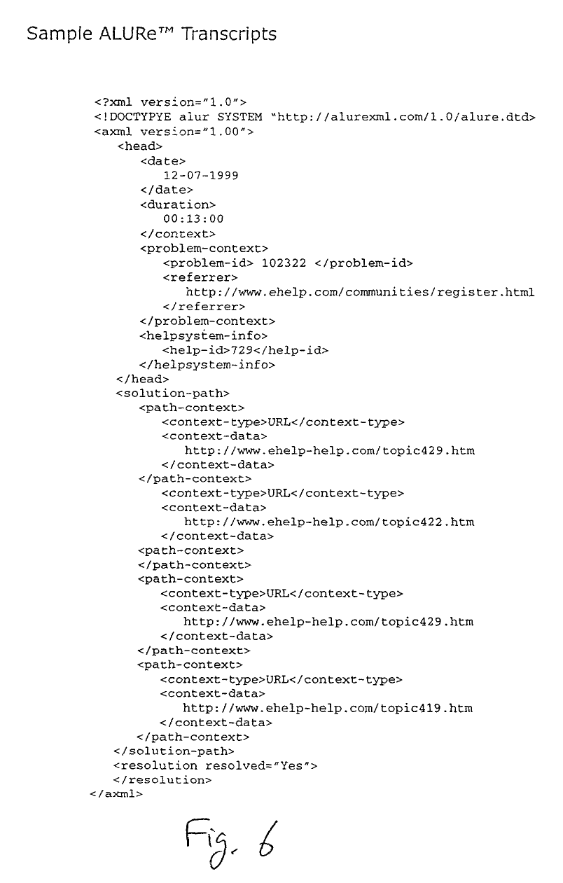

FIG. 6 shows a typical ALURe entry for a user's movements in the help system. ALURe records the user's information including the referring website, the list of help topics requested by the user, and whether the problem was resolved.

The recorded data is aggregated and reported to the website developers, at stage 4. The data is reported in the form of customized reports specifically designed for the particular website. The invention may also generate a set of standard, canned reports containing data for parameters common to all sites.

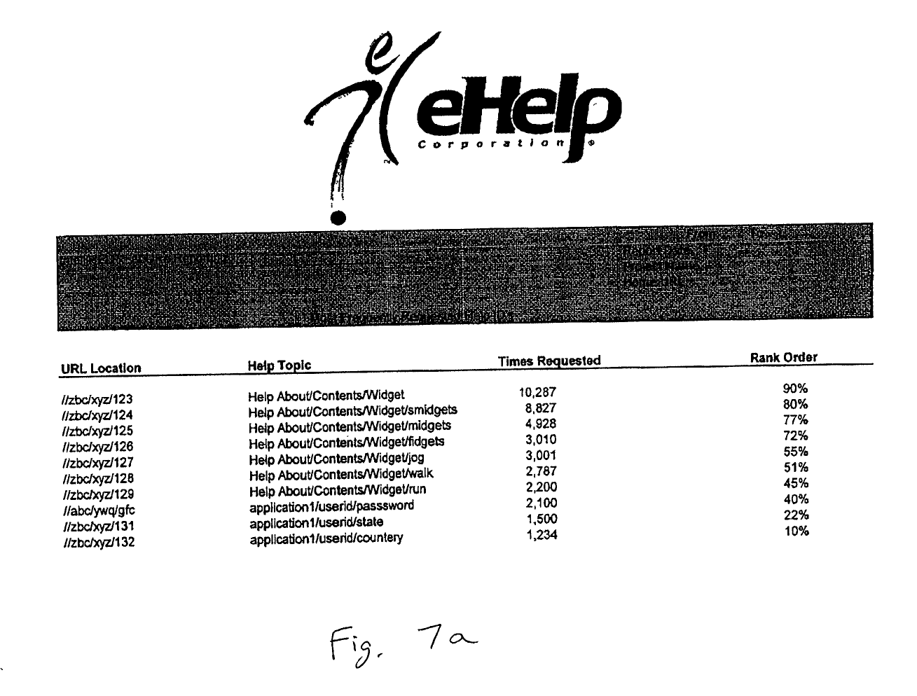

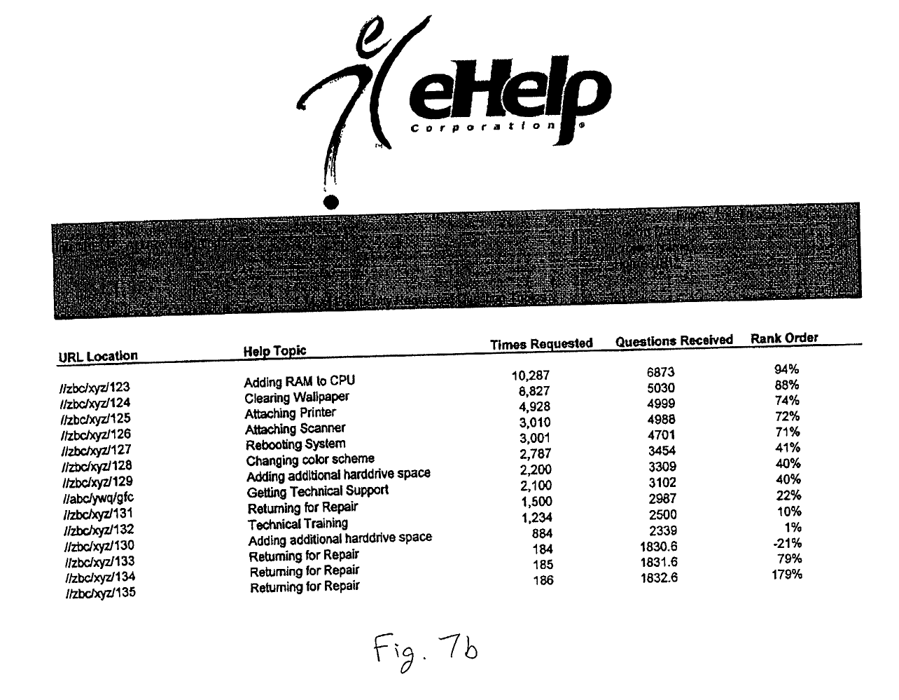

FIGS. 7a and 7b are samples of reports generated by the invention. FIG. 7a shows a report with a listing of the help topics listed according to the frequency requests. The topic requested most frequently is listed at the top, and a rank order is calculated. The sample report shown in FIG. 7b includes an additional column listing how often users submitted questions to the web masters by, for example, electronic mail. Other reports may aggregate data pertaining to factors such as:

most frequently requested search terms

most frequently asked natural language questions

ratio of multiple visits to single visits

average time spent in the help system

multiple help system usages per transaction

browser frequency

analysis of solution paths (average length, entry and exit points)

In one embodiment, the invention makes the reports accessible electronically via the Internet and through an administration application. Thus, the website administrators are provided with a comprehensive compilation of data through which problem areas may be identified.

In stage 5 (FIG. 1), the website developers use the reports generated by the invention to modify the website to eliminate the problem areas of the site. Thus, the comprehensive feedback mechanism of the present invention allows continual improvement of the website.

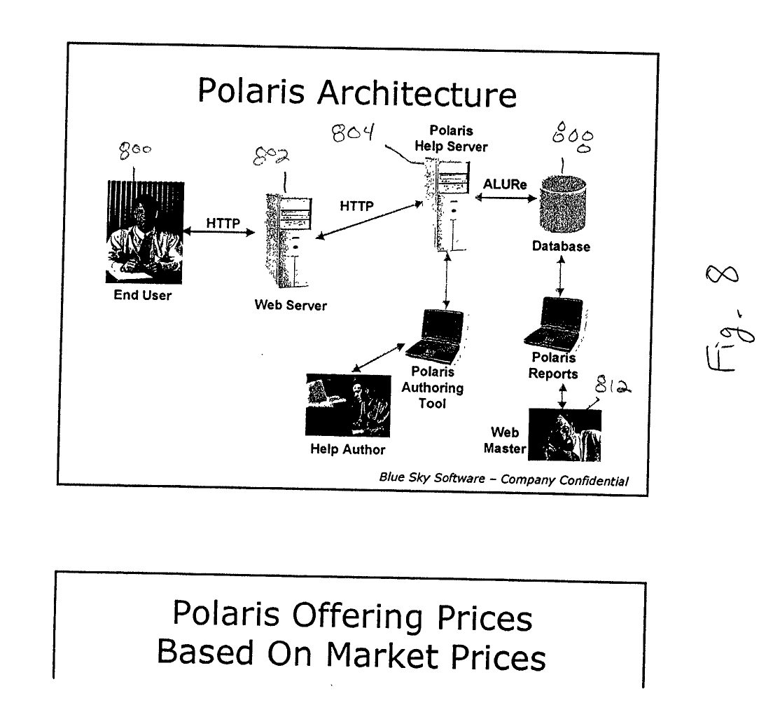

FIG. 8 illustrates an architecture of an embodiment of the present invention. The user 800 accesses the help system from the Help Server 804 via the Web Server 802. The invention records the user's movements within the help system according to ALURe on a database 808. The help system generates reports from the database for access by the Web Master 812, who is now able to pinpoint trouble areas and modify the website accordingly.

By tracking and reporting help usage patterns, the invention provides data aggregation for determining the type of problems encountered by users, the point in the transaction at which the problems were encountered, the steps taken by the user in attempting to resolve the problem, and whether the user succeeded in resolving the problem. This data allows website developers to constantly refine their websites and to eliminate the problem areas. Improved usability of the website results in a reduced number of users abandoning the site and increases the efficiency of the site.

The foregoing description details certain embodiments of the invention. It will be appreciated, however, that no matter how detailed the foregoing appears, the invention may be embodied in other specific forms without departing from its spirit or essential characteristics. The described embodiment is to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A method of maintaining a website, the method comprising:
providing electronic help on a website;
collecting usage data from the electronic help; and
providing at least one report, said report being indicative of the usage data.

2. The method of maintaining a website of claim 1, further comprising modifying the website based on said report.

3. The method of maintaining a website of claim 1, wherein said report is generated automatically upon receipt of usage data.

4. The method of maintaining a website of claim 1, wherein said usage data includes a user browser type.

5. The method of maintaining a website of claim 1, wherein said usage data includes a user address.

6. The method of maintaining a website of claim 1, wherein said usage data includes a requested help topic.

7. A system for website help, comprising:
a tracking module adapted to track and log movements of a user in a help environment;
a recording module adapted to record information pertaining to the user and to the movements; and
a reporting module adapted to report usage of the help environment.

8. The system for website help of claim 7, wherein said recording module is further adapted to record a user browser type.

9. The system for website help of claim 7, wherein said recording module is further adapted to record a user address.

10. The system for website help of claim 7, wherein said recording module is further adapted to record a requested help topic.
